(19) United States
(12) Patent Application Publication
(10) Pub. No.: US 2017/0249805 A1
(43) Pub. Date: Aug. 31, 2017

(54) METHODS AND DEVICES FOR PLAYING A CARD GAME

(71) Applicant: AGS, LLC, Las Vegas, NV (US)

(72) Inventor: Joni Renee Johnston, Sahuarita, AZ (US)

(21) Appl. No.: 15/054,399

(22) Filed: Feb. 26, 2016

(51) Int. Cl. G07F 17/32; A63F 1/00

(52) U.S. Cl. CPC G07F 17/3293; A63F 1/00; G07F 17/3244; G07F 17/3262; A63F 2001/005

(57) ABSTRACT

A method of playing and presenting a game offers player multiple betting options and card hand formation elections. In one embodiment, each player places an ante wager and may place one or more proposition bets. Each player and the dealer are dealt 5 playing cards. If a player does not fold, the player forms a player two card flush hand and a three card hand from their 5 cards. If a dealer's two card flush hand does not qualify, the player wins. Otherwise, the player's two card flush hand is compared to the dealer's two card flush hand. If the player wins, winnings may be paid at least in part based upon the player's three card hand. Winnings may also be paid for winning position bets, regardless of whether the player folded or not.

### FIELD OF THE INVENTION

The present invention relates to methods of presenting and playing games and devices configured to present games.

### BACKGROUND OF THE INVENTION

While players like fast paced, exciting games, many players are reticent to play a new game because of their unfamiliarity with the game. Thus, one object is to develop new games that are easy to understand and play, and yet are exciting.

### SUMMARY OF THE INVENTION

Embodiments of the invention comprise methods of playing and presenting games and gaming devices and systems for implementing the game.

In one embodiment of the invention, a method of playing and presenting a game offers players the opportunity for multi-tier wagering and side or proposition bets, and the strategic challenge of forming multiple game hands. The games are played using game pieces, such as physical or virtual game pieces such as playing cards.

In one embodiment of the game, a player places an ante wager and, optionally, one or more proposition bets. An initial set of cards is dealt to each player and the dealer, such as five (5) initial cards. The player then elects to fold or elects to not fold by placing a secondary wager.

Each player who did not fold forms a two hands from their initial set of cards or game pieces. In one embodiment, one hand comprises a two card flush hand (two cards of the same suit) and the other hand comprises a three card hand.

In one embodiment, the outcome of the game depends upon whether the dealer qualifies. In one embodiment, the dealer qualifies if a dealer two card flush hand formed from the dealer's initial cards comprises a minimum rank.

If the dealer does not qualify, then each player who did not fold may be declared a winner of the game and may be paid winnings, such as 1:1 on their ante wager (and may be returned their secondary wager).

If the dealer does qualify, the outcome of the game as to each player who did not fold is determined by comparing the player's two card flush hand to the dealer's two card flush hand. A tie may be declared if the hands have the same rank; the player may be declared the winner if the player's hand outranks the dealer's hand; and the player may be declared a loser if the dealer's hand outranks the player's hand. In the event the player's two card flush hand is winning, winnings may be paid to the player. In one embodiment, winnings may be paid at least in part based upon the player's three card hand, such as based upon a rank of the player's three card hand as compared to a pay table.

Regardless of whether the player folded or did not fold, the proposition bets are resolved. In one embodiment, a proposition bet may comprise a flush hand bet that the player's initial dealt cards comprise a minimum flush hand of three cards. In another embodiment, a proposition bet may comprise a 5 card hand bet that the player's initial dealt cards will comprise a poker hand of a minimum rank. Winnings may be paid for winning proposition bets, such as based up a pay table.

The games of the invention may be presented at a gaming table using physical playing cards, using chips and including a gaming table layout. The games of the invention might also be presented via an electronic gaming device or system, such as by displaying graphical images of game pieces. In other embodiments, the games of the invention may be played using game pieces other than playing cards, such as dice.

Further objects, features, and advantages of the present invention over the prior art will become apparent from the detailed description of the drawings which follows, when considered with the attached figures.

### DESCRIPTION OF THE DRAWINGS

FIG. 1 is a flow chart which illustrates one method of playing and/or presenting a game in accordance with the invention;

FIG. 2 illustrates one embodiment of a game table and associated game layout for playing and presenting a game of the invention; and

FIG. 3 illustrates one embodiment of a gaming machine for presenting a game in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. One embodiment of the invention comprises a game, and preferably a card game, where a player forms sub-hands from a set of cards.

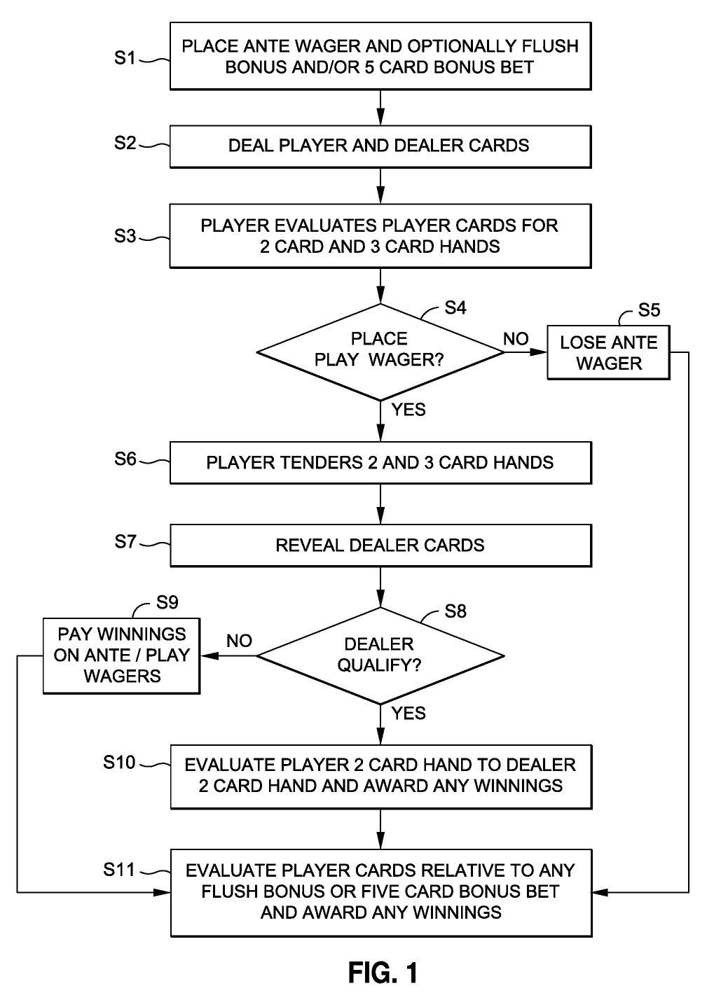

FIG. 1 is a flow diagram which illustrates a method of presenting and playing a game in accordance with one embodiment of the invention. In one embodiment, the game is played by a dealer or the house (which may comprise a live person or a virtual dealer) and one or more players. As detailed herein, the game might be played or presented at a gaming machine or device, at a gaming table or the like. In a preferred embodiment, the game is played at a gaming table by a dealer and at least one player, such as up to 6 or 8 players or more.

Preferably, the game is presented as a wagering game in which a player is required to place a wager in order to play the game and where the player has the opportunity to be awarded winnings. Thus, in one embodiment, in a step S1, a player places an ante or initial wager in order to participate in the game. Optionally, a participating player may place one or more proposition bets such as a flush bonus bet and/or a 5 card bonus bet. The ante wager may be required to be of a certain minimum size and may also have a maximum size. The player may, but is preferably not required, to place a proposition bet such as the flush bonus bet and/or the 5 card bonus bet. The flush bonus bet and the 5 card bonus bet comprise proposition bets that a player's set of game pieces (such as cards) will have certain characteristics. In one embodiment, as described further below, the flush bonus bet may comprise a bet that certain player cards will comprise at least a three card flush. The 5 card bonus bet may comprise a bet that certain player cards will have a minimum rank, such as a pair of sixes. Of course, other proposition bets and/or proposition bets having different criteria or characteristics might be offered. As with the ante wager, the proposition bets might be a minimum amount and/or maximum amount. In one embodiment, a player may place a flush bonus bet, a 5 card bonus bet, or both. In other embodiments, a player might only be permitted to place one of the proposition bets, but not both.

In a step S2, one or more initial game or playing pieces are provided to each player and the dealer. In a preferred embodiment, the game is played with playing cards, such as cards dealt from one of more decks of standard playing cards (e.g. cards having the indicia 2 3, 4, 5, 6, 7, 8, 9, 10, Jack, Queen, King and Ace in each of the four suits Hearts, Clubs, Spades and Diamonds). Of course, other playing pieces might be utilized such as dice, etc. As described below, the playing pieces may comprise physical playing pieces, such as physical printed cards, physical dice or the like, or might comprise virtual playing pieces, such as graphical images of the playing pieces displayed on one or more electronic video displays.

In one embodiment, in a step S2 an initial set of five (5) playing cards are dealt to each player and the dealer. Preferably, at least the dealer cards are dealt face down (e.g. with a back of the playing card face up and a face which displays the card indicia/values face down and not visible to the players).

In a step S3, each player inspects their initial cards and evaluates them for a two (2) card hand and a three (3) card hand. In one embodiment the player's two card hand must comprise a two card flush hand, e.g. two cards of the same suit (such as two cards having the suit Hearts, Diamonds, Clubs or Spades in the event one or more standard decks of playing cards are used). If the player has three or more cards of the same suit in their initial set of cards, they may or may not select the two cards of the same suit which have the highest rank, because as described below, game winnings to the player may depend upon the remaining cards in the player's three card hand.

In step S4, the player then elects to either fold or to not fold by placing at least one secondary wager. In one embodiment, each player who does not fold is required to place a secondary wager in the form of a “Play” wager. If the player folds (e.g. does not place the required Play wager), then the player loses their ante wager but is preferably still entitled to participate in any placed proposition bet(s), as indicated in steps S5 and S11. The Play wager may have a certain minimum size, such as comprising a secondary wager equal to the player's ante wager. The secondary wager may also have a maximum size.

In a step S6, the player preferably tenders their two card hand and their three card hand. For example, as described below, the player might tender their two card hand to a particular location on a gaming table and may tender their three card hand to another location on the gaming table.

In a step S7, the dealer reveals the dealer's initial card(s) or game piece(s). For example, in the case of playing cards, the dealer may turn over their initial cards so that the card faces which display the card indicia are displayed to the players.

In a step S8, the dealer's initial cards may be evaluated for the dealer's best 2 card flush hand. In one embodiment, the dealer might set aside the dealer's two card hand in a particular location, such as a particular location on a gaming table. The dealer's two card hand is evaluated to determine if it qualifies. In one embodiment, the dealer's two card hand must have at least one card having a Jack or higher ranking (e.g. a Jack high flush or better).

In a step S9, if the dealer's two card hand does not qualify, then the outcome of the game may be determined without reference to the player's cards or two card flush hand. In one embodiment, winnings may automatically be paid to the player. In one embodiment, the player's Play wager is returned (e.g. a “push”) and the player's ante wager is paid an even money (e.g. the player's ante wager is returned along with an equal amount of winnings).

In a step S10, if the dealer's hand does qualify, then each active player's two card hand is compared to the dealer's two card hand. In one embodiment, this step applies to active players, e.g. those players that placed all required wagers (in the embodiment described above, the ante wager and the Play wager). In this step S10, each active player's two card hand is compared to the dealer's two card hand, such as to determine which hand has the highest rank. In one embodiment, the hand with the highest rank is determined to be the winner. Tie hands may be declared a push.

In the event the player's hand is a winning hand, the player may be paid winnings. In one embodiment, if the player's two card hand outranks the dealer's two card hand, then the player's ante wager is paid even money (e.g. the player's ante wager is returned and the player is paid an equal amount of winnings) and winnings are paid on the player's Play wager based upon the player's three card hand as compared to a pay table. Such a pay table might comprise the following:

TABLE A
PLAY WAGER PAYTABLE

| | |
|---|---|
| Mini Royal (Ace/King/Queen of the same suit): | 50 to 1 |
| Straight Flush (consecutively ranked cards of same suit): | 30 to 1 |
| Trips (three cards of the same rank): | 10 to 1 |
| Straight (three cards of consecutive rank, any suit): | 5 to 1 |
| Flush (three cards of the same suit): | 3 to 1 |
| Pair (two cards of the same rank): | 2 to 1 |
| None of the above: | 1 to 1 |

If the player's two card hand ranks lower than the dealer's two card hand, the player's two card hand is losing. In that event, the player preferably loses both their ante and Play wagers (e.g. those wagers are collected by the house/dealer).

If the player's two card hand ties (e.g. has the same rank as) the dealer's two card hand, then the hands may be declared a tie and the wagers may “push”, e.g. the player's ante and Play wagers may simply be returned with no payment of winnings.

In a step S11, the proposition bets are evaluated. In one embodiment, for each player who placed a flush bonus bet (regardless of whether the player placed a Play wager or folded, and regardless of the outcome of the player's two card hand as compared to the dealer's two card hand), this evaluation comprises determining if the player's five card hand (e.g. the player's five dealt cards—e.g. the player's two card hand in combination with the remaining three cards dealt to the player) comprises at least a three card flush (three (3) cards of the same suit). In one embodiment, if the player's hand does not meet this criteria, the player loses their flush bonus bet. In one embodiment, if the player's hand does, then the player may be paid winnings, such as in accordance with the following pay table:

TABLE B
FLUSH BONUS PAY TABLE

| | |
|---|---|
| 5 Card Royal Flush (10 through Ace of the same suit): | 250 to 1 |
| 5 Card Straight Flush (consecutively ranked cards of the | 100 to 1 |
| same suit): | |
| 3 Card Mini Royal Flush (Ace/King/Queen of the same suit): | 30 to 1 |
| 5 Suited Cards/Flush (5 cards of the same suit): | 10 to 1 |
| 4 Suited Cards/Flush (4 cards of the same suit): | 4 to 1 |
| 3 Suited Cards/Flush (3 cards of the same suit): | 1 to 1 |

In one embodiment, for each player who placed a 5 card bonus bet (regardless of whether the player placed a Play wager or folded, and regardless of the outcome of the player's two card hand as compared to the dealer's two card hand), this evaluation comprises determining if the player's five card hand comprises at least a minimum criteria or rank, such as a poker hand ranking of a minimum rank of a pair of sixes. In one embodiment, if the player's hand does not meet this criteria, then the player loses their 5 card bonus bet. In one embodiment, if the player's hand does, then the player may be paid winnings, such as in accordance with the following pay table:

TABLE C
5 CARD BONUS PAY TABLE

| | |
|---|---|
| Royal Flush: | 250 to 1 |
| Straight Flush: | 100 to 1 |
| Four of a Kind: | 40 to 1 |
| Full House: | 15 to 1 |
| Flush: | 10 to 1 |
| Straight: | 6 to 1 |
| Three of a Kind: | 4 to 1 |
| Two Pair: | 3 to 1 |
| Pair of 6s or Better: | 1 to 1 |

Various aspects of the invention will now be appreciated. As one aspect of the invention, excitement and strategy are involved in a player forming two hands of cards from an initial set of cards. Importantly, the selection of cards used in one hand affects the other. This forces a player to make strategic decisions when forming the hand. For example, a player might be dealt three or more cards of the same suit, thus allowing the player to pick two of the three cards to form the player's two card hand. In so doing, the player must consider that the remaining card will impact the rank or value of the three card hand, thus potentially affecting winnings to the player.

As one example, a player might be dealt the five cards comprising: 6♡, J♡, A♡, 2♦ and A [symbol] . If the player selects the A♡ and the J♡ or 6♡ for their two card hand, they have a higher probability of their two card hand beating the dealer's two card hand because of the inclusion of the A♡. However, the player's remaining three card hand would then not even comprise a pair, and thus would only be entitled to a 1:1 payout in accordance with the pay table herein. On the other hand, if the player selected the J♡ and 6♡ as their two card hand, their chanced of beating a qualifying dealer hand would be low, but if the player's two card hand won, then the players three card hand would include a pair of Aces, and thus paid winnings would double to 2:1.

In this regard, in one embodiment of the invention, the outcome of the game may be determined by examination of one hand of the player (their two card flush hand) but the amount of winnings paid to the player may depend at least in part upon the other hand of the player (the rank of the three card hand).

In one embodiment, a game offers a player multiple wagering options, such as a two tier wagering option comprising an ante or initial wager and a secondary or Play wager. Each level of wagering increases the excitement of the game due to the increases risk as the wagers compile, and wherein the outcome of those wagers is tied to the same outcome criteria (such as a comparison of the player's hand to the dealer's hand and an evaluation of the player's three card hand). In a preferred embodiment, if the player does not place the Play wager, then the player folds and automatically loses the ante wager.

The game preferably also offers at least one separate wager, such as one or more proposition bets. These bets are preferably independent of the wagers and have an outcome which is determined apart from the criteria of the wagers. In a preferred embodiment, the player is eligible to play out the side or proposition bets even if the player folds and loses their wagers. Players who placed proposition bets thus remain interested in the game until the end, even if they have folded along the way, because they remain eligible for a proposition bet win.

In one embodiment, a variety of winnings may be paid. In one embodiment, winnings may be paid based upon one or more pay tables which offer increased or high payouts. These payouts generate game excitement due to the probability of potentially high wins in comparison so the size of wagers or bets placed. Other types of winnings than monies or monetary value credits/chips might be awarded, such as points, tangible prizes, discounts or the like.

As indicated, the game of the invention may be implemented in various manners, such as via various gaming machines, devices and/or systems.

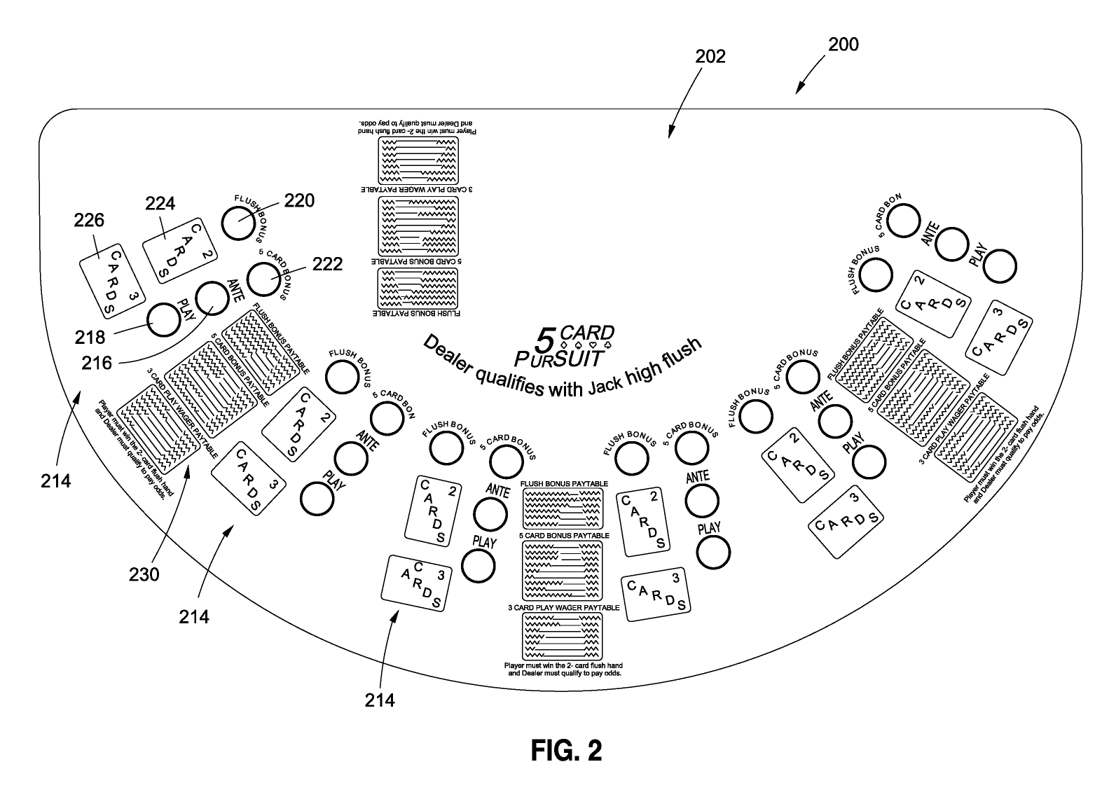

As one example, the game of the invention might be presented at a gaming table. For example, as illustrated in FIG. 2, games of the invention may be implemented in a “table” format. In such a configuration, the game may be presented at a gaming table using physical game pieces, such as physical playing cards.

As illustrated in FIG. 2, a game playing surface, such as a gaming table 200 or board is provided. The gaming table 200 (or a surface thereof, such as a “gaming felt” or other covering which is applied to the surface, printing on the gaming table or the like) may include or define a dealer station 202 where a dealer may run a game as described above. The dealer station 202 may include dealer controls to administer the game, an automatic card shuffler and/or card shoe (now shown), and the like.

The table 200 also includes or defines one or more player stations 214. In one embodiment, each player station 214 comprises an area or portion of the table or its play surface.

In one embodiment, the table 200 defines one or more game play features. Such features may be defined by printing on the table or its covering surface, by one or more displays and/or by surface or topographical features such as depressed areas, raised areas, contours or the like.

In one embodiment, each player station 214 preferably defines an ante wager area 216, a Play wagering area 218, a flush bonus bet area 220 and a 5 card bonus bet area 224, such as defined by printing, raised or depressed areas or the like. Each player station 214 might also comprise an two card hand area 226 and a three card hand area 228, such as to where the player may tender those hands.

These various areas may be defined by printing or the like, as detailed above. Of course, the table may include other areas or information, such as other card areas, pay tables, instructions and the like 230.

The player stations 214 might also or alternatively include a number of electronic controls for placing wagers or designating game play decisions (such as “fold” decision) to the dealer. The wagering and bet areas may be configured to automatically detect a wager via RFID, NFC, or other similar means, such as by detecting the placement of one or more RFID tagged wagering chips in those areas. Alternatively, one or more of the wagering areas might comprise a slot or the like into which a chip, coin, etc. may be inserted (and in some embodiments, wager accepting devices might comprise monetary value transfer devices or interfaces, such as by which a player might transfer monetary value, points or the like from a casino account, bank account or the like for use in placing wagers, which wagers might then be placed using chips or might be placed electronically).

The gaming table 200 may optionally include one or more displays, such as electronic video displays. The displays may show game information to the players, such as a payout table, a status of bets and wagers, etc. There may also be a camera (not shown) disposed above the table. The camera may output images to the display so that the players and other onlooker may easily watch the game as it progresses. In another embodiment, the player and/or dealers areas might include one or more electronic displays for displaying game information electronically (images of cards, etc.). The displays might also include a touch screen or be associated with other input devices (buttons, keypad, etc.) for receiving wager information from a player, etc.

The size of the gaming board or table 200 may vary, as may its shape, etc. The top or playing surface of the gaming table 200 may preferably be elevated, such as by legs, etc.

Relative to a gaming table 200 such as that in FIG. 2, a player desiring to play the game preferably places an ante wager, such as by placing one or more chips at the ante wager area 216. The player may optionally place the first or second proposition bets at those corresponding areas 220,222, and may place the Play wager at that area 218, such as by placing one or more chips at that area.

As indicated, wagers might be placed in manners other than by using/placing monetary value chips. Wagers might be placed using coins, currency, or electronically, such as via electronic credits or monetary value, such as associated with an account or balance of credits/monies.

As indicated herein, the game is preferably played using one or more standard decks of 52 physical cards comprising the cards 2, 3, 4, 5, 6, 7, 8, 9, 10, J, Q, K and Ace in each of the suits of Hearts, Diamonds, Spades and Clubs, wherein the suit and rank of each card is displayed on a first side of the card and the opposite side of the card defines a card back which does not display the card suit and rank, such as via printing on a media (such as paper/card stock).

In one embodiment, the cards may be dealt from a shuffled deck or a shoe of multiple cards. The cards may also be dealt or provided by an automatic card shuffling device. Of course, the game might be played with other sets or types of cards, such as one or more decks of cards with one or more wildcards or Jokers or other types of cards.

The game table 200 may include other devices or features and/or be linked to other devices or systems. For example, the game table 200 (or the card shoe) might include a card reader which is configured to read dealt cards for use in verifying game outcomes. In this regard, the gaming table 200 might include a processor, at least one memory, machine-readable code which is stored in the at least one memory and executable by the processor for implementing various features. As one example, the processor might obtain data regarding dealt cards (such as from a card reader) and determine the value of the players and dealer hands, such as for generating an output of game outcomes, such as winning and losing results, winnings to be paid, etc. The gaming table processor might be linked to or communicate with other devices or systems, such as a casino accounting system. Such systems might be used to track player play, amounts wagered and won and the like, as is well known in the art.

The methods of game play and presentation may also be implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

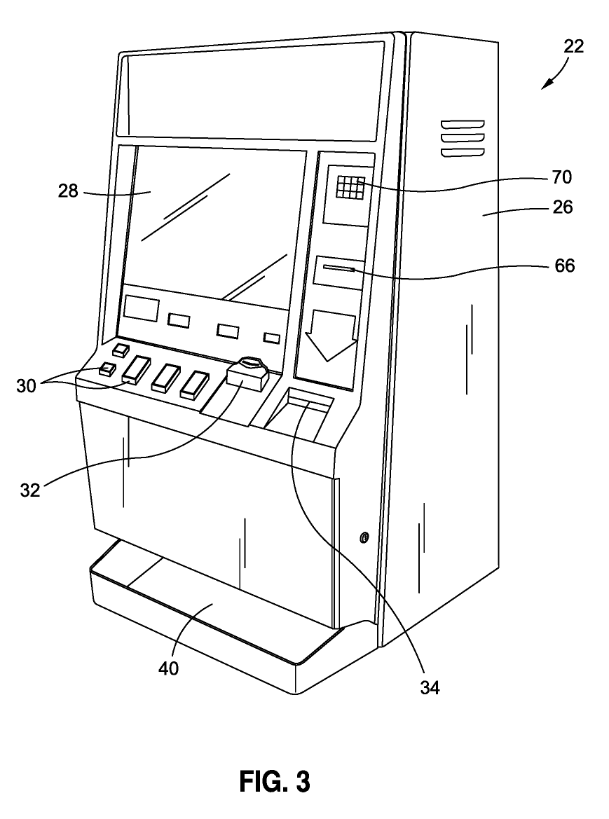

One configuration of a gaming machine 22 is illustrated in FIG. 3. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate game pieces such as playing cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information comprising dealt or displayed game pieces such as playing cards, as detailed below), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting playing cards or other game pieces and for presenting the game in a random fashion (e.g. whereby the game is presented in a manner in which the player cannot control the outcome).

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game symbols or other game information to be displayed on the at least one display 28. The controller may accept input from a player of game inputs, such as a request to spin reels or the like, via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds, or via a wager accepting device which facilitates electronic funds transfer, such as from a casino account, remote bank account, card or the like. For example, as illustrated in FIG. 3, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 3 is only exemplary of one embodiment of a gaming machine. For example, it is possible to for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

It will be appreciated that the methods of the invention may be implemented in other manners than as described herein. For example, the steps of the method(s) may be performed in other orders and/or might include additional or other steps.

As indicated herein, aspects of the invention might be applied to other games or games using other game pieces. For example, the method of the invention might apply to a dice type game where dice indicia are utilized and a player attempts to receive or achieve certain dice combinations and the player might form two hands of dice.

Further, other combinations of game pieces may be utilized. For example, each player and the dealer might be dealt six (6) cards and might form the best two and three card hands from those cards, or might form a two card hand and a four card hand, etc. Also, additional wagers might be required to play the game and/or additional or other proposition bets might be offered.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of presenting a game to one or more players at a gaming table, comprising the steps of:
receiving an ante wager from each player at an ante wager location defined by said gaming table and, optionally, at least one proposition bet at at least one proposition bet location defined by said gaming table;
dealing a set of physical playing cards to each player and a dealer;
receiving an election from said each player to fold, or to not fold by placing at least one secondary wager, said at least one secondary wager received at one or more secondary wagering locations defined by said gaming table;
receiving an election of a player two card flush hand and a player three card hand from each player who did not fold, said player two card hand and player three card hand formed from said set of physical cards dealt to said player;
determining if a dealer two card flush hand formed from said set of physical cards dealt to said dealer qualifies said dealer, wherein if said dealer does not qualify, awarding winnings to each player who did not fold, and wherein if said dealer does qualify and said player did not fold, comparing said player's two card flush hand to said dealer's two card flush hand to determine an outcome of said game; and
determining an outcome of each proposition bet placed by each player regardless of whether said player folded or did not fold.

2. The method in accordance with claim 1 wherein said at least one proposition bet comprises a flush hand bet that said set of physical cards dealt to said player comprises a flush hand comprising at least three cards.

3. The method in accordance with claim 2 comprising awarding winnings for said flush bet based upon the following pay table of hands:

| | |
|---|---|
| 5 Card Royal Flush (10 through Ace of the same suit): | 250 to 1 |
| 5 Card Straight Flush (consecutively ranked cards of the | 100 to 1 |
| same suit): | |
| 3 Card Mini Royal Flush (Ace/King/Queen of the same suit): | 30 to 1 |
| 5 Suited Cards/Flush (5 cards of the same suit): | 10 to 1 |
| 4 Suited Cards/Flush (4 cards of the same suit): | 4 to 1 |
| 3 Suited Cards/Flush (3 cards of the same suit): | 1 to 1 |

4. The method in accordance with claim 1 wherein said proposition bet comprises a 5 card hand bet that said set of physical cards dealt to said player comprises a poker hand.

5. The method in accordance with claim 4 comprising awarding winnings for said 5 card hand bet based upon the following pay table of poker hands:

| | |
|---|---|
| Royal Flush: | 250 to 1 |
| Straight Flush: | 100 to 1 |
| Four of a Kind: | 40 to 1 |
| Full House: | 15 to 1 |
| Flush: | 10 to 1 |
| Straight: | 6 to 1 |
| Three of a Kind: | 4 to 1 |
| Two Pair: | 3 to 1 |
| Pair of 6s or Better: | 1 to 1 |

6. The method in accordance with claim 1 wherein said set of determining if said dealer two card hand qualifies comprises determining if said dealer's two card flush hand comprises a rank of at least a Jack high flush or higher.

7. The method in accordance with claim 1 wherein if said dealer does not qualify, awarding said winnings comprising a 1:1 payout on said ante wager placed by said player and a push on said at least one secondary wager placed by said player.

8. The method in accordance with claim 1 wherein said initial set of physical cards dealt to each player and said dealer comprises an initial set of five physical playing cards.

9. The method in accordance with claim 1 further comprising said player tendering said player two flush card hand to a two card hand location defined by said gaming table and tendering said three card hand to a three card hand location defined by said gaming table.

10. The method in accordance with claim 1 wherein said ante and secondary wagers and one or more proposition bets are placed with physical chips.

11. The method in accordance with claim 1 wherein said ante and secondary wagering and proposition bet locations are defined by printed areas on a table felt of said gaming table.

12. The method in accordance with claim 1 wherein said player loses their ante wager if they fold.

13. The method in accordance with claim 1 wherein said step of comparing said player's two card flush hand to said dealer's two card flush hand to determine an outcome of said game comprises declaring said outcome of said game to be a tie if said player's two card hand has the same rank as said dealer's two card hand, declaring said outcome of said game to be losing at to said player if said player's two card hand has a lower rank than said dealer's two card hand, and declaring said outcome of said game to be winning to said player if said player's two card hand outranks said dealer's two card hand.

14. The method in accordance with claim 13 wherein if said outcome of said game to said player is a tie, returning said ante wager and said at least one secondary wager placed by said player.

15. The method in accordance with claim 13 wherein if said outcome of said game to said player is losing, said player losing said ante wager and said at least one secondary wager.

16. The method in accordance with claim 13 wherein if said outcome of said game to said player is winning, paying winning to said player based upon said player's three card hand.

17. The method in accordance with claim 16 wherein said winning are paid based upon the following pay table as to said player's three card hand:

| | |
|---|---|
| Mini Royal (Ace/King/Queen of the same suit): | 50 to 1 |
| Straight Flush (consecutively ranked cards of same suit): | 30 to 1 |
| Trips (three cards of the same rank): | 10 to 1 |
| Straight (three cards of consecutive rank, any suit): | 5 to 1 |
| Flush (three cards of the same suit): | 3 to 1 |
| Pair (two cards of the same rank): | 2 to 1 |
| None of the above: | 1 to 1 |

18. A gaming machine comprising:
a controller;
at least one electronic display;
at least one player input device;
machine-readable code executable by said controller to accept an ante wager and, optionally, at least one proposition bet;
machine-readable code executable by said controller cause said electronic display to deal an initial set of cards to the player and the dealer;
machine-readable code executable by said controller to cause said controller to receive an election from said at least one player to fold, or to not fold by placing at least one secondary wager;
machine-readable code executable by said controller to cause said controller to, as to each player who did not fold, receive an election of a player two card flush hand and a player three card hand;
machine-readable code executable by said controller to cause said controller to determine if a dealer two card flush hand formed from said set of physical cards dealt to said dealer qualifies said dealer, and if said dealer does not qualify and said player did not fold, award winnings to said player, and if said dealer does qualify and said player did not fold, comparing said player's two card flush hand to said dealer's two card flush hand to determine an outcome of said game; and
machine-readable code executable by said controller to cause said controller to determine an outcome of each proposition bet placed by each player regardless of whether said player folded or did not fold.
